(19) United States
(12) Patent Application Publication
(10) Pub. No.: US 2023/0239244 A1
(43) Pub. Date: Jul. 27, 2023

(54) HEAVY HITTER FLOW DETECTION

(71) Applicant: Intel Corporation, Santa Clara, CA (US)

(72) Inventors: Ningbo TIAN, Shanghai (CN); Xiahui YU, Shanghai (CN); Kun QIU, Shanghai (CN); Hao CHANG, Shanghai (CN); Yong LIU, Shanghai (CN); Hongjun NI, Shanghai (CN)

(21) Appl. No.: 18/127,881

(22) Filed: Mar. 29, 2023

(30) Foreign Application Priority Data
Mar. 9, 2023 (WO) PCT/CN2023/080484

(51) Int. Cl. H04L 47/11; H04L 47/122; H04L 43/062

(52) U.S. Cl. CPC H04L 47/11; H04L 47/122; H04L 43/062

(57) ABSTRACT

Examples described herein relate to a programmable packet processing pipeline configured to: access a data corresponding to multiple bins, respective bins associated with multiple packet flows and for respective bins: identify a single flow associated with a bin of the multiple bins as a candidate heavy hitter flow and determine a different packet flow as the candidate heavy hitter flow for the bin of the multiple bins.

### RELATED APPLICATION

This application claims priority to PCT/CN2023/080484, filed Mar. 9, 2023. The entire contents of that application are incorporated by reference in its entirety.

### BACKGROUND

In datacenter or internet service provider (ISP) networks, there could be more than millions of flows active at a time. In some cases, approximately 5% of the flows can account for more than 70% of the entire network traffic. Such flows are called heavy hitters or elephant flows and can account for the majority of network traffic over a certain amount of time. Heavy hitters can increase latency for delay-sensitive mice flows and can be a source of network congestion. Heavy hitter detection can be utilized in a variety of applications, such as: distributed denial of service (DDoS) attack detection and prevention, flow-size aware routing, load balancing, traffic engineering, quality of service (QoS), among others. Network administrators attempt to detect heavy hitters promptly and take timely actions to mitigate congestion arising from heavy hitter flows.

### BRIEF DESCRIPTION OF THE DRAWINGS

FIG. 1 depicts an example system.

FIG. 2 depicts an example system.

FIG. 3 depicts an example sketch structure.

FIG. 4 depicts an example process.

FIG. 5 depicts an example pseudocode.

FIG. 6 depicts an example system.

FIG. 7 depicts an example system.

### DETAILED DESCRIPTION

Some examples include a packet processing system configured to access data corresponding to multiple bins. A bin of the multiple bins can be associated with one or more packet flows. For a bin, the packet processing system can identify a single flow as a candidate heavy hitter flow and determine a different packet flow as the candidate heavy hitter flow for the bin. For example, the packet processing system can identify a single flow associated with a bin of the multiple bins as a candidate heavy hitter flow based on monitoring traffic volume of multiple packet flows associated with the bin. For example, the packet processing system can: based on a flow of a received packet corresponding to the different packet flow and the candidate heavy hitter flow, increase a heavy hitter flow vote count for the candidate heavy hitter flow. In some examples, the programmable packet processing pipeline can: based on a number of heavy hitter votes for the candidate heavy hitter flow, cause performance of actions for a heavy hitter flow. In some examples, a single datum is to identify the candidate heavy hitter flow and a number of votes that the candidate heavy hitter flow is a heavy flow and monitor traffic of one or more flows that are not heavy hitter candidate flows. For example, a newly arriving packet can cause updating of votes that a flow of the newly arriving packet is a heavy hitter flow or votes that the newly arriving packet is not a heavy hitter flow. A packet recirculated to the packet processing system can carry a key for a flow corresponding to the recirculated packet is to be updated in a bin as a candidate heavy hitter flow as well as a number of votes that one or more flows associated with the bin are a heavy hitter flow and a number of votes that one or more flows associated with the bin are not a heavy hitter candidate flow.

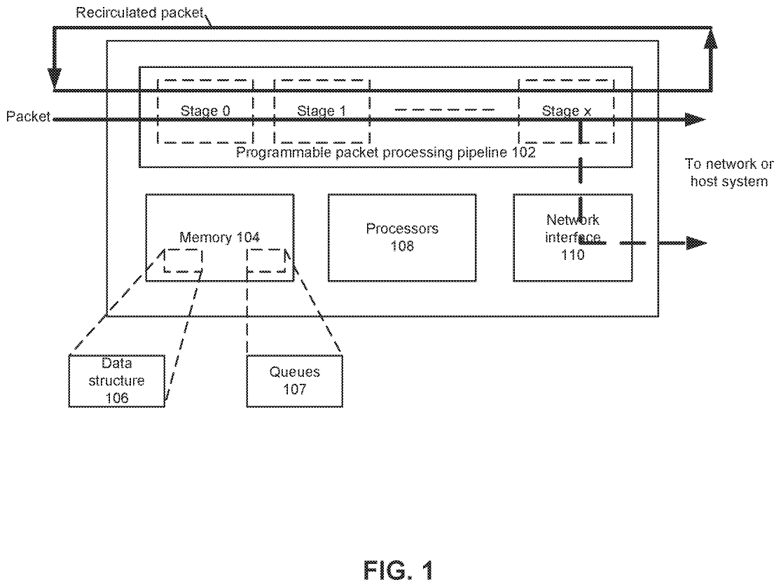

FIG. 1 depicts an example system. Packet processing pipeline 102 can include multiple packet processing stages 0 to x, where x is an integer. One or more of stages 0 to x can access memory 104 to retrieve and/or store packet header, packet payload, metadata, data structure 106, or other data or metadata described herein. Programmable packet processing pipeline 102 can include a multi-stage data plane that includes one or more of: application specific integrated circuit (ASIC), field programmable gate arrays (FPGAs), processors, or other circuitry. Packet processing pipeline 102 can be implemented as a Protocol-Independent Switch Architecture (PISA). For example, packet processing pipeline 102 can be programmed using a packet processing pipeline language based on one or more of: Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

In some examples, one or more stages of packet processing pipeline 102 can perform heavy hitter detection (HHD) and indicate, in data structure 106, one or more flows that are detected as heavy hitters or elephant flows based on a comparison with a threshold number of packets received for the flow over a period of time. For example, a control plane, administrator, or user can specify X number of packets received for a single flow over a period of Y seconds can correspond to a heavy hitter or elephant flow. HHD can perform voting as to whether a flow is a heavy hitter flow or not a heavy hitter flow by accumulating yes (heavy hitter) and no (not heavy hitter) votes based on receipt of packets of a flow. When a flow has the potential to grow into a heavy flow, HHD can replace an entry in data or data structure 106 for the flow with a flow identified as a candidate heavy hitter flow. As HHD runs repeatedly, heavy hitter flows can be identified and entries for flows identified as candidate heavy hitter flows can be replaced by entries for another candidate heavy hitter flow and, accordingly, reduce memory resource utilization to store data structure 106 or otherwise identify heavy hitter flows.

In some examples, data structure 106 can include an index value, associated key value, counts of yes votes that a flow corresponds to a heavy hitter flow, and counts of no votes that a flow corresponds to a heavy hitter flow. As a size of data structure 106 is limited, one or more stages of packet processing pipeline 102 can attempt to reduce a number of non-heavy hitter flows identified in data structure 106. For a determined index value, based on a key value in the data structure not matching a determined key value for a packet, pipeline 101 can replace the key value in data structure 106 with the determined key value for the packet. As described herein, the packet can be recirculated through one or more stages of packet processing pipeline 102 to replace the key value in the data structure for the determined index value. Replacing the key value in the data structure for the determined index value can occur based on an indication that the flow is a candidate heavy hitter flow. For example, the flow can be identified as a candidate heavy hitter flow based on a comparison of a number of votes that the flow is not a heavy flow versus a number of votes that the flow corresponds to a heavy flow. Accordingly, an entry in data structure 106 can be updated to identify the candidate heavy hitter flow and a number of votes that the candidate heavy hitter flow is a heavy flow and monitor traffic of one or more flows that are not heavy hitter candidate flows. Packet processing pipeline 102 can attempt to reduce entries associated with flows that are potentially mouse flows or not heavy hitter flows. When the non-heavy hitter flow votes grow larger than a multiple of the heavy hitter flow votes for a currently identified heavy hitter flow, the speed of growth of packets for the flow currently identified as a heavy hitter flow is small enough so that the currently identified heavy hitter flow can be replaced by another identified potential heavy hitter flow.

For example, a first stage of multiple packet processing stages can access identifier (ID) to retrieve a key value. A second stage of multiple packet processing stages can determine a vote_y (e.g., yes votes that the flow corresponds to a heavy flow) but does not access memory accessed by the first stage. A third stage of multiple packet processing stages can determine a vote_n (e.g., votes that the flow corresponds to multiple flows where two or more flows can collide or be associated with the entry corresponding to the identifier) but does not access memory accessed by the first stage or the second stage. To replace or adjust a key value to identify another candidate heavy hitter flow, the packet can be recirculated to the first stage with a flag indicating the packet is recirculated and information to place in the replaced entry in data structure 106. The information can include an index carried with the recirculated packet, new key value for the next candidate heavy hitter flow, and number of yes votes that the flow associated with the index is a heavy hitter flow and number of votes that the next candidate heavy hitter flow is not a heavy flow (e.g., vote_n).

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field). A packet flow can be identified by a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Processors 108 can be configured by an orchestrator or host computing system to configure pipeline 102 to perform HHD. Network interface 110 can include Media Access Control (MAC) circuitry, a reconciliation sublayer circuitry, and physical layer interface (PHY) circuitry. PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, network interface 110 can transmit packets to other network elements that are to be forwarded at direction of pipeline 102.

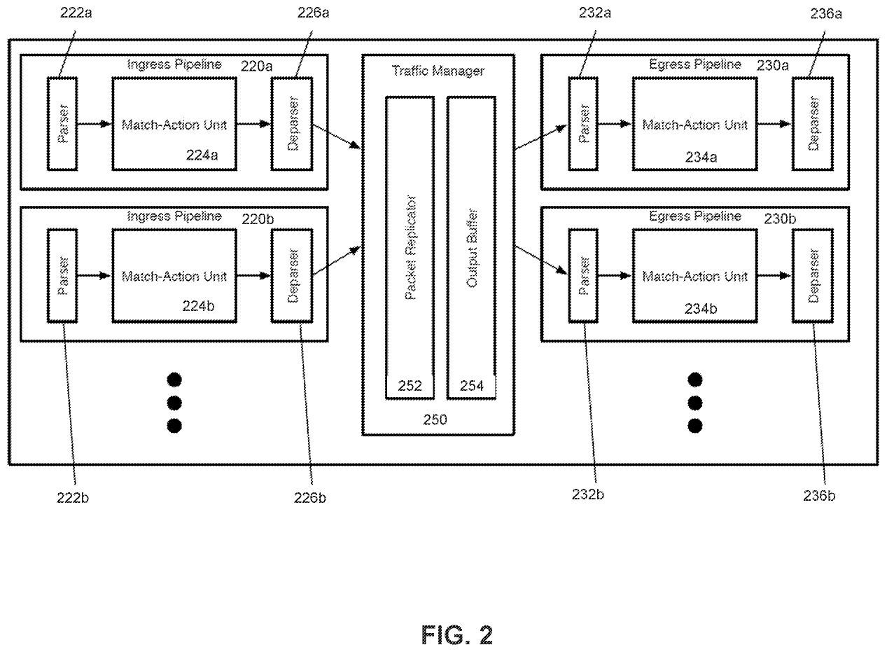

FIG. 2 depicts an example network forwarding system that can be used as a switch or router. One or more of ingress pipelines 220 can be configured to identify potential heavy flows by use of data that identify a single flow as a candidate heavy hitter flow and a number of votes that one or more flows associated with the bin are a heavy flow and a number of votes that one or more flows associated with the bin are not a heavy flow, as described herein. For example, FIG. 2 illustrates several ingress pipelines 220, a traffic management unit (referred to as a traffic manager) 250, and several egress pipelines 230. Though shown as separate structures, in some examples the ingress pipelines 220 and the egress pipelines 230 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

In some examples, in response to receiving a packet, the packet is directed to one of the ingress pipelines 220 where an ingress pipeline which may correspond to one or more ports of a hardware forwarding element. After passing through the selected ingress pipeline 220, the packet is sent to the traffic manager 250, where the packet is enqueued and placed in the output buffer 254. In some examples, the ingress pipeline 220 that processes the packet specifies into which queue the packet is to be placed by the traffic manager 250 (e.g., based on the destination of the packet or a flow identifier of the packet). The traffic manager 250 then dispatches the packet to the appropriate egress pipeline 230 where an egress pipeline may correspond to one or more ports of the forwarding element. In some examples, there is no necessary correlation between which of the ingress pipelines 220 processes a packet and to which of the egress pipelines 230 the traffic manager 250 dispatches the packet. In other words, a packet might be initially processed by ingress pipeline 220b after receipt through a first port, and then subsequently by egress pipeline 230a to be sent out a second port, etc.

A least one ingress pipeline 220 includes a parser 222, a chain of multiple match-action units (MAUs) or match-action circuitries 224, and a deparser 226. Similarly, egress pipeline 230 can include a parser 232, a chain of MAUs or match-action circuitries 234, and a deparser 236. The parser 222 or 232, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 222 or 232 separates out the packet headers (up to a designated point) from the payload of the packet, and sends the payload (or the entire packet, including the headers and payload) directly to the deparser without passing through the MAU processing. Egress parser 232 can use additional metadata provided by the ingress pipeline to simplify its processing.

MAUs 224 or 234 can perform processing on the packet data. In some examples, the MAUs includes a sequence of stages, with each stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU.

Deparser 226 or 236 can reconstruct the packet using the PHV as modified by the MAU 224 or 234 and the payload received directly from the parser 222 or 232. The deparser can construct a packet that can be sent out over the physical network, or to the traffic manager 250. In some examples, the deparser can construct this packet based on data received along with the PHV that specifies the protocols to include in the packet header, as well as its own stored list of data container locations for each possible protocol's header fields.

Traffic manager 250 can include a packet replicator 252 and output buffer 254. In some examples, the traffic manager 250 may include other components, such as a feedback generator for sending signals regarding output port failures, a series of queues and schedulers for these queues, queue state analysis components, as well as additional components. Packet replicator 252 of some examples performs replication for broadcast/multicast packets, generating multiple packets to be added to the output buffer (e.g., to be distributed to different egress pipelines).

Output buffer 254 can be part of a queuing and buffering system of the traffic manager in some examples. The traffic manager 250 can provide a shared buffer that accommodates any queuing delays in the egress pipelines. In some examples, this shared output buffer 254 can store packet data, while references (e.g., pointers) to that packet data are kept in different queues for each egress pipeline 230. The egress pipelines can request their respective data from the common data buffer using a queuing policy that is control-plane configurable. When a packet data reference reaches the head of its queue and is scheduled for dequeuing, the corresponding packet data can be read out of the output buffer 254 and into the corresponding egress pipeline 230. In some examples, packet data may be referenced by multiple pipelines (e.g., for a multicast packet). In this case, the packet data is not removed from this output buffer 254 until all references to the packet data have cleared their respective queues.

In some examples, a memory or queue that stores packets is different from the memory that tracks the per-queue resource consumption metrics. Packet buffers or queues can be part of a traffic manager (TM) 250 and resource consumption metrics can be computed and tracked in match-action pipes, at ingress or egress pipelines. TM 250 can provide the queue depth or queueing time information part of per-packet metadata so that the egress or ingress pipeline can use that information to calculate the overall metrics and make the compare and update decision on the metrics carried in the packet header.

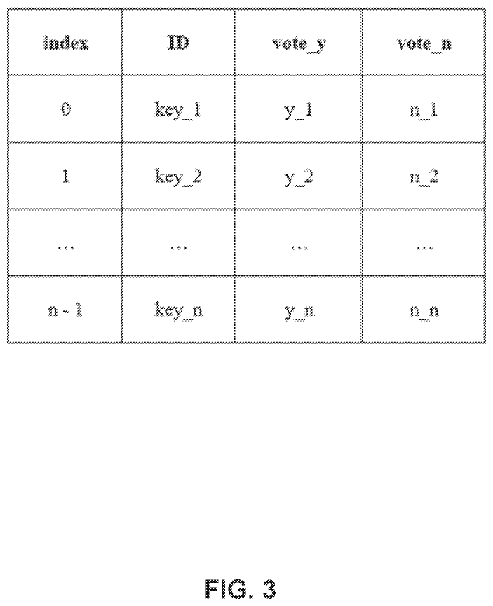

FIG. 3 depicts an example data structure. HHD can use a sketch data structure or data to store flow identifier and packet count votes for a flow being a heavy hitter flow or the flow being a non-heavy hitter flow. The sketch can include an integer n number of buckets, datum, or indices. Inside a bucket or datum, fields can be set as identifier (ID), vote_y, and vote_n. ID can refer to an identifier of a candidate heavy hitter flow, vote_y can refer to a count of votes that one or more flows associated with this bucket is a heavy hitter flow, and vote_n can refer to a count of votes that one or more flows associated with this bucket is not a heavy hitter flow.

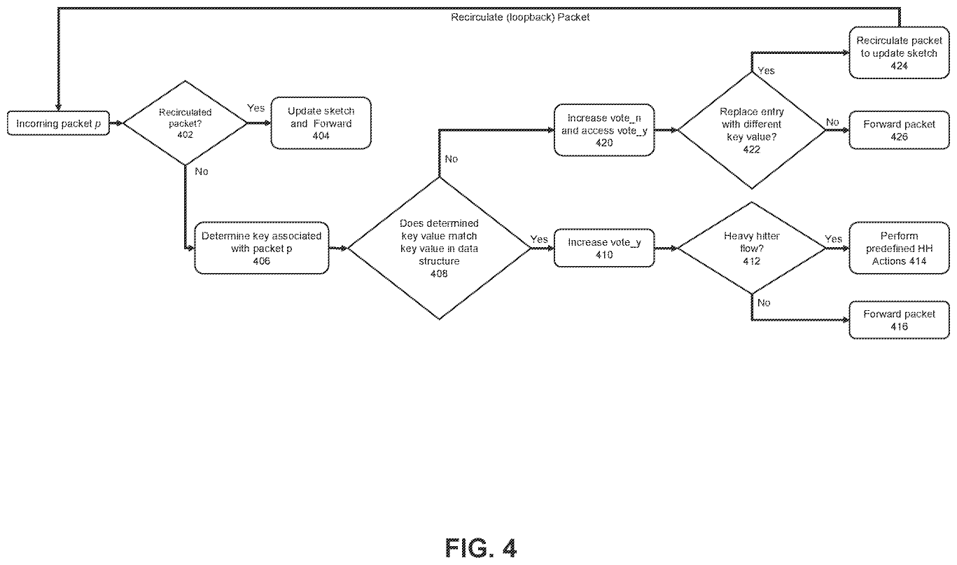

FIG. 4 depicts an example process. The process can be performed by a packet processing pipeline circuitry in some examples. At 402, based on receipt of a packet at an ingress port or availability for processing by a stage of a packet processing pipeline, a determination can be made as to whether packet was recirculated. For example, the packet can be determined to have been recirculated based on a flag or indicator in a header or payload of the packet where the flag or indicator indicates that the packet was recirculated. Based on the packet having been recirculated, the process can continue to 404. Based on the packet not having been recirculated, the process can continue to 406.

At 404, a data structure that tracks at least information related to identifying heavy hitter flows can be updated based on content of the recirculated packet. For example, the content used to update the data structure can include an index value, updated key value corresponding to the recirculated packet is to be updated in a bin as a candidate heavy hitter flow as well as a number of votes that one or more flows associated with the bin are a heavy hitter flow (vote_y) and a number of votes that one or more flows associated with the bin are not a heavy hitter candidate flow (vote_n). In the data structure, for the index value, the updated key value, value of vote_y, and value of vote_n can replace former key value, value of vote_y, and value of vote_n.

At 406, a key associated with a flow of the received packet can be determined. For example, based on a set of header fields of the packet p (e.g., destination IP address, source IP address, or other tuple), a key for the packet (key_p) can be determined and an index can be determined based on a hash of the key_p. In some examples, the hash of the key_p can be based on cyclic redundancy check (CRC) 16 (CRC-16). A current value of a key stored in the data structure for the determined index can be determined as key_t.

At 408, a determination can be made as to whether a key value in the data structure, for the determined index, matches the determined key value for the packet. If the key value in the data structure, for the determined index, matches the determined key value for the packet, the process proceeds to 410. If the key value in the data structure, for the determined index, does not match the determined key value for the packet, the process proceeds to 420. If the current value of the key does not match a key associated with the index in the data structure and there is no empty index bucket in the data structure, a hash collision occurred and the index stores a key for a different flow.

If the key matches an existing key for an existing index or is a new key for a new index, at 410, a vote for y (heavy hitter) can be incremented for the determined index value. For example, the vote for y (vote_y) for the entry associated with the index can be incremented. At 412, a determination can be made of whether the flow is identified as a heavy hitter flow. For example, if vote_y≥a threshold count value for a time window, then the key is associated with a heavy hitter flow. Based on the flow being identified as a heavy hitter flow, at 414, one or more remedial actions can be performed: queuing: put them in low-priority queue while mice go to high-priority; flow rate control (e.g., allocate fair bandwidth to the flow); traffic engineering (e.g., route packets of the flow through high-bandwidth paths); determine causes of congestion and report congestion to sender; or drop the packet. In some examples, if the threshold is not met, the vote_y count may or may not be updated despite packet forwarding.

In some examples, congestion can be reported in metadata of in-band telemetry schemes such as those described in: “In-band Network Telemetry (INT) Dataplane Specification, v2.0,” P4.org Applications Working Group (February 2020); IETF draft-lapukhov-dataplane-probe-01, “Data-plane probe for in-band telemetry collection” (2016); and IETF draft-ietf-ippm-ioam-data-09, “In-situ Operations, Administration, and Maintenance (IOAM)” (Mar. 8, 2020), or Internet Engineering Task Force (IETF) draft-kumar-ippm-ifa-01, “Inband Flow Analyzer” (February 2019). In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4.

For example, at 412, if vote_y<threshold value of counts for a heavy hitter flow for a time window, then the flow is not identified as a heavy hitter. Based on the flow not being identified as a heavy hitter flow, at 416, the packet can be forwarded to another network device or terminated at a host. Packet processing pipeline can perform routing lookup for the packet to determine a next hop using the packet processing pipeline.

Based on the key for the current packet not matching a key stored for an index in the data structure, at 420, a vote for not a heavy hitter flow (vote_n) can be incremented. At 420, the vote for y (heavy hitter flow) stored in the entry associated with the index can be retrieved. In some examples, votes for y (vote_y) can be only associated with one flow identified in a current entry for an index whereas votes for n (vote_n) can be associated with one or more flows associated with the entry for the index. In some examples, the votes for y can be associated with one or more flows associated with the index. In some examples, votes for y (vote_y) can be accessed and increased and votes for n (vote_n) can be accessed in a next stage of the pipeline.

At 422, a determination can be made as to whether the entry associated with the index is to be updated with another flow identifier. For example, based on number of votes that the flow is not a heavy hitter flow being above a threshold level for a time window, the flow can be considered a candidate to replace an identified flow in the entry. For example, if vote_n>M*vote_y, where M is 2 or more, then the flow can be considered a candidate to replace an identified flow in the entry. Based on the entry associated with the index being associated with the flow considered a candidate to replace an identified flow in the entry, at 424, the current packet can be recirculated with content that includes an index value, determined key value (key_p) for the flow considered a candidate to replace an identified flow in the entry, vote_y for the current flow identified as a heavy hitter flow in the entry, and vote_n for the flow considered a candidate to replace the flow identified as a heavy hitter flow in the entry. In a next processing of the recirculated packet, in order to update the flow considered a candidate to replace an identified flow in the entry, the determined key value for the flow considered a candidate to replace an identified flow in the entry (key_p), vote_y, and vote_n can be stored in the data structure for the index.

Accordingly, a bin of multiple bins can identify a single flow as a candidate heavy hitter flow and a number of votes that the candidate heavy hitter flow is a heavy flow and a number of votes that one or more flows associated with the bin are not a heavy flow to monitor traffic of one or more flows that are not heavy hitter candidate flows. A flow considered a candidate can replace an identified flow in the entry. For example, an index 1 with key_2 identifies a candidate heavy hitter flow. In a first packet recirculation, for index 1, key_2 can be changed to key_5 to identify another candidate heavy hitter flow. In a second packet recirculation, for index 1, key_5 can be replaced by key_6 to identify another candidate heavy hitter flow. In a third packet recirculation, for index 1, key_6 can be replaced key_7, a new candidate heavy hitter flow.

Based on the entry associated with the index is associated with a heavy hitter flow, at 426, the packet can be forwarded to a next destination or terminated at a host.

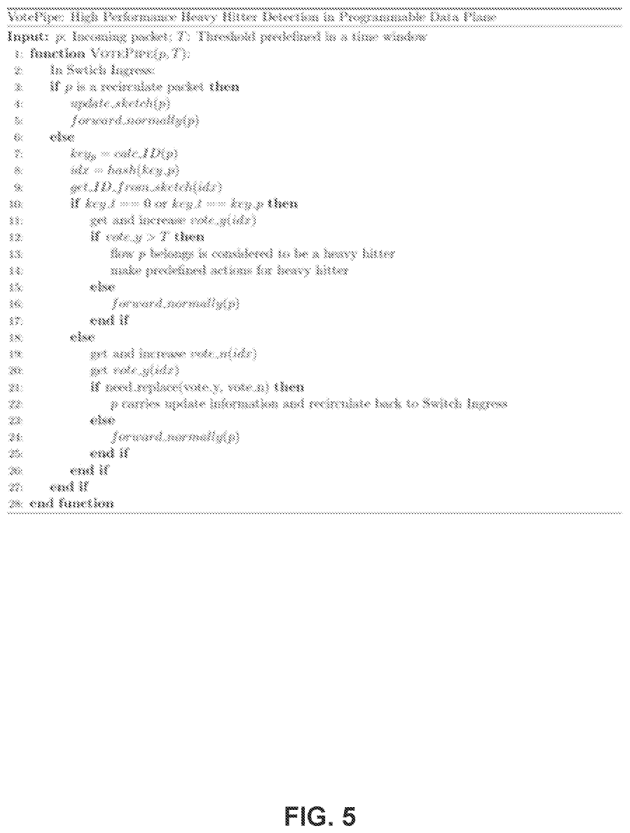

FIG. 5 depicts an example HHD pseudocode. A threshold-based schema can be used to estimate flow size in a time window to identify whether a flow is a heavy hitter. Flows stored previously in buckets can be replaced with trackers of flows that have the potential to become heavy hitters. By use of voting and replacement, as many as bucket number n can be stored, which can improve memory utilization.

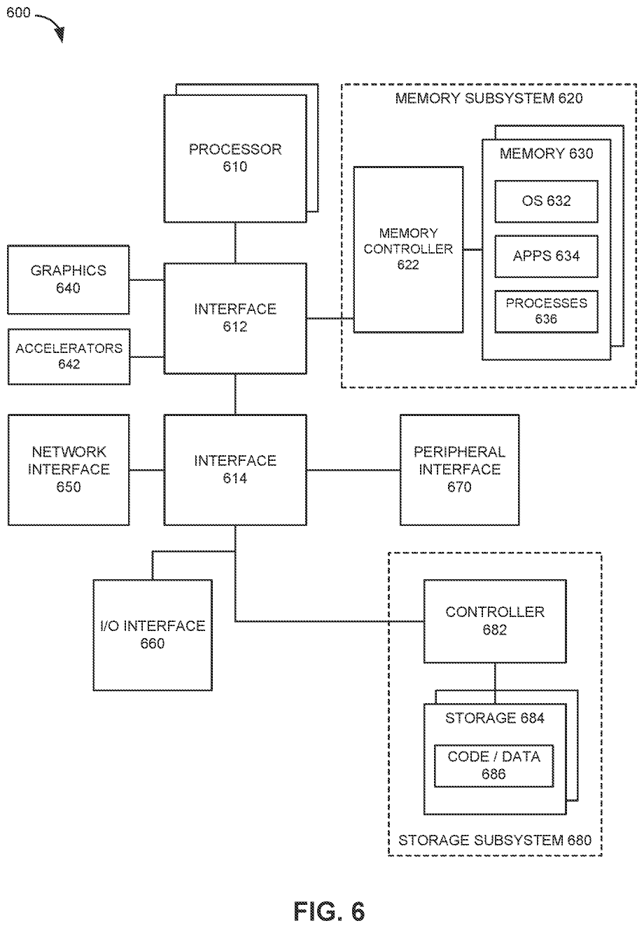

FIG. 6 depicts an example computing system. Components of system 600 (e.g., processor 610, network interface 650, and so forth) can be configured to identify potential heavy flows by use of data that identify a single flow as a candidate heavy hitter flow and a number of votes that one or more flows associated with the bin are a heavy flow and a number of votes that one or more flows associated with the bin are not a heavy flow, as described herein. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. In some examples, graphics interface 640 generates a display based on data stored in memory 630 or based on operations executed by processor 610 or both. In some examples, graphics interface 640 generates a display based on data stored in memory 630 or based on operations executed by processor 610 or both.

Accelerators 642 can be a fixed function or programmable offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 642 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory.

Network interface 650 can include one or more of: a network interface controller (NIC), a remote direct memory access (RDMA)-enabled NIC, SmartNIC, router, switch, or network-attached appliance. Some examples of network interface 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. For example, one or more programmable pipelines or fixed function processors or other circuitry can be configured to identify potential heavy flows by use of data that identify a single flow as a candidate heavy hitter flow and a number of votes that one or more flows associated with the bin are a heavy flow and a number of votes that one or more flows associated with the bin are not a heavy flow, as described herein.

For example, network interface 650 can include Media Access Control (MAC) circuitry, a reconciliation sublayer circuitry, and physical layer interface (PHY) circuitry. The PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, at least where network interface 650 is a router or switch, the router or switch can include interface circuitry that includes a SerDes.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. A volatile memory is memory whose state (and therefore the data stored in it) is indeterminate if power is interrupted to the device. A non-volatile memory (NVM) device is a memory whose state is determinate even if power is interrupted to the device. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-Volatile Memory Express over Fabrics (NVMe-oF) (e.g., NVMe-oF specification, version 1.0 (2016) as well as variations, extensions, and derivatives thereof) or NVMe (e.g., Non-Volatile Memory Express (NVMe) Specification, revision 1.3c, published on May 24, 2018 (“NVMe specification”) as well as variations, extensions, and derivatives thereof).

Communications between devices can take place using a network that provides die-to-die communications; chip-to-chip communications; circuit board-to-circuit board communications; and/or package-to-package communications. One or more components of system 600 can be implemented as part of a system-on-chip (SoC).

Examples herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

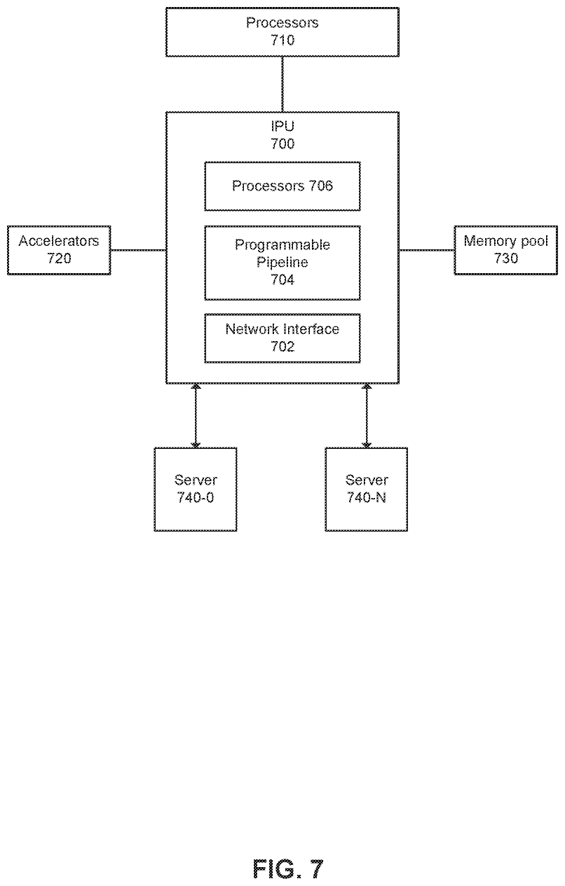

FIG. 7 depicts an example network interface device. Network interface device 700 manages performance of one or more processes using one or more of processors 706, processors 710, accelerators 720, memory pool 730, or servers 740-0 to 740-N, where N is an integer of 1 or more. In some examples, processors 706 of network interface device 700 can execute one or more processes, applications, VMs, containers, microservices, and so forth that request performance of workloads by one or more of: processors 710, accelerators 720, memory pool 730, and/or servers 740-0 to 740-N. Network interface device 700 can utilize network interface 702 or one or more device interfaces to communicate with processors 710, accelerators 720, memory pool 730, and/or servers 740-0 to 740-N. Network interface device 700 can utilize programmable pipeline 704 to process packets that are to be transmitted from network interface 702 or packets received from network interface 702.

Programmable pipeline 704 and/or processors 706 can be configured or programmed using programmable pipeline languages. Programmable pipeline 704 and/or processors 706 can be configured to identify potential heavy flows by use of data that identify a single flow as a candidate heavy hitter flow and a number of votes that one or more flows associated with the bin are a heavy flow and a number of votes that one or more flows associated with the bin are not a heavy flow, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes an apparatus comprising: a programmable packet processing pipeline configured to: access a data corresponding to multiple bins, respective bins associated with multiple packet flows and for respective bins: identify a single flow associated with a bin of the multiple bins as a candidate heavy hitter flow and determine a different packet flow as the candidate heavy hitter flow for the bin of the multiple bins.

Example 2 includes one or more examples, wherein the identify a single flow associated with a bin of the multiple bins as a candidate heavy hitter flow is based on monitored traffic volume of multiple packet flows associated with a respective bin.

Example 3 includes one or more examples, wherein the programmable packet processing pipeline is to monitor traffic of non-heavy hitter candidate flows in a single datum.

Example 4 includes one or more examples, wherein the programmable packet processing pipeline is configured to: based on a flow of a received packet corresponding to the different packet flow and the candidate heavy hitter flow, increase a heavy hitter flow vote count for the candidate heavy hitter flow.

Example 5 includes one or more examples, wherein the programmable packet processing pipeline is configured to: based on a number of heavy hitter votes for the candidate heavy hitter flow, cause performance of actions for a heavy hitter flow.

Example 6 includes one or more examples, wherein a single datum of the data is to identify the candidate heavy hitter flow and a number of votes that the candidate heavy hitter flow is a heavy flow and monitor traffic of one or more non-heavy hitter candidate flows.

Example 7 includes one or more examples, wherein the programmable packet processing pipeline is configured to: based on a key value associated with the packet being stored in the data: cause performance of an action, wherein the action comprises one or more of: queue the packet into a lower-priority queue; perform flow rate control; cause the packet to be routed through a high-bandwidth path; identify congestion and report congestion to a sender of the packet; or drop the packet.

Example 8 includes one or more examples, wherein the programmable packet processing pipeline is configured to: based on a key value associated with the packet being stored in the data and based on a level of heavy hitter vote count, cause forwarding of the packet.

Example 9 includes one or more examples, wherein the programmable packet processing pipeline is configured based on one or more of: Protocol-independent Packet Processors (P4), Software for Open Networking in the Cloud (SONiC), C, Python, Broadcom Network Programming Language (NPL), NVIDIA® CUDA®, NVIDIA® DOCA™ Infrastructure Programmer Development Kit (IPDK), or x86 compatible executable binaries or other executable binaries.

Example 10 includes one or more examples, and includes a method that includes: identifying a heavy hitter flow in a data comprising multiple buckets by replacing the identified heavy hitter flow in a bucket of the multiple buckets with a second candidate heavy hitter flow.

Example 11 includes one or more examples, wherein a programmable packet processing pipeline performs the identifying the heavy hitter flow in the data.

Example 12 includes one or more examples, wherein the replacing the identified heavy hitter flow in a bucket with a second candidate heavy hitter flow comprises updating votes that one or more flows associated with the bucket are a heavy hitter and votes that the second candidate heavy hitter flow is not a heavy hitter flow.

Example 13 includes one or more examples, and includes increasing a heavy hitter vote count for the identified heavy hitter flow based on storage in the bucket of a key value associated with the identified heavy hitter flow.

Example 14 includes one or more examples, and includes based on a count of votes that a flow of a packet is not a heavy hitter flow, causing recirculation of the packet to update the bucket with the count of votes that a flow of a packet is not a heavy hitter flow and a count of votes that one or more flows associated with the bucket are a heavy hitter.

Example 15 includes one or more examples, and includes based on a key value associated with a packet not being stored in the data and based on a count of votes that a flow of a packet is not a heavy hitter flow, forwarding the packet.

Example 16 includes one or more examples, and includes based on a key value associated with a packet being stored in the data: cause performance of an action, wherein the action comprises one or more of: queue the packet into a lower-priority queue; perform flow rate control; cause the packet to be routed through a high-bandwidth path; identify congestion and report congestion to a sender of the packet; or drop the packet.

Example 17 includes one or more examples, and includes at least one non-transitory computer-readable medium comprising instructions stored thereon, that if executed by a packet processing circuitry, cause the packet processing circuitry to: access a data corresponding to multiple bins, respective bins associated with multiple packet flows and for respective bins: identify a single flow associated with a bin of the multiple bins as a candidate heavy hitter flow and determine a different packet flow as the candidate heavy hitter flow for the bin of the multiple bins.

Example 18 includes one or more examples, wherein the identify a single flow associated with a bin of the multiple bins as a candidate heavy hitter flow is based on monitored traffic volume of multiple packet flows associated with a respective bin.

Example 19 includes one or more examples, wherein the packet processing circuitry is to monitor traffic of non-heavy hitter candidate flows in a single datum.

Example 20 includes one or more examples, and includes instructions stored thereon, that if executed by the packet processing circuitry, cause the packet processing circuitry to: based on a flow of a received packet corresponding to the different packet flow and the candidate heavy hitter flow, increase a heavy hitter flow vote count for the candidate heavy hitter flow.

What is claimed is:

1. An apparatus comprising:
a programmable packet processing pipeline configured to:
access a data corresponding to multiple bins, respective bins associated with multiple packet flows and
for respective bins:
identify a single flow associated with a bin of the multiple bins as a candidate heavy hitter flow and
determine a different packet flow as the candidate heavy hitter flow for the bin of the multiple bins.

2. The apparatus of claim 1, wherein the identify a single flow associated with a bin of the multiple bins as a candidate heavy hitter flow is based on monitored traffic volume of multiple packet flows associated with a respective bin.

3. The apparatus of claim 1, wherein the programmable packet processing pipeline is to monitor traffic of non-heavy hitter candidate flows in a single datum.

4. The apparatus of claim 1, wherein the programmable packet processing pipeline is configured to:
based on a flow of a received packet corresponding to the different packet flow and the candidate heavy hitter flow, increase a heavy hitter flow vote count for the candidate heavy hitter flow.

5. The apparatus of claim 1, wherein the programmable packet processing pipeline is configured to:
based on a number of heavy hitter votes for the candidate heavy hitter flow, cause performance of actions for a heavy hitter flow.

6. The apparatus of claim 1, wherein a single datum of the data is to identify the candidate heavy hitter flow and a number of votes that the candidate heavy hitter flow is a heavy flow and monitor traffic of one or more non-heavy hitter candidate flows.

7. The apparatus of claim 1, wherein the programmable packet processing pipeline is configured to:
based on a key value associated with the packet being stored in the data:
cause performance of an action, wherein the action comprises one or more of: queue the packet into a lower-priority queue; perform flow rate control; cause the packet to be routed through a high-bandwidth path; identify congestion and report congestion to a sender of the packet; or drop the packet.

8. The apparatus of claim 1, wherein the programmable packet processing pipeline is configured to:
based on a key value associated with the packet being stored in the data and based on a level of heavy hitter vote count, cause forwarding of the packet.

9. The apparatus of claim 1, wherein the programmable packet processing pipeline is configured based on one or more of: Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

10. A method comprising:
identifying a heavy hitter flow in a data comprising multiple buckets by replacing the identified heavy hitter flow in a bucket of the multiple buckets with a second candidate heavy hitter flow.

11. The method of claim 10, wherein a programmable packet processing pipeline performs the identifying the heavy hitter flow in the data.

12. The method of claim 11, wherein the replacing the identified heavy hitter flow in a bucket with a second candidate heavy hitter flow comprises updating votes that one or more flows associated with the bucket are a heavy hitter and votes that the second candidate heavy hitter flow is not a heavy hitter flow.

13. The method of claim 10, comprising:
increasing a heavy hitter vote count for the identified heavy hitter flow based on storage in the bucket of a key value associated with the identified heavy hitter flow.

14. The method of claim 10, comprising:
based on a count of votes that a flow of a packet is not a heavy hitter flow, causing recirculation of the packet to update the bucket with the count of votes that a flow of a packet is not a heavy hitter flow and a count of votes that one or more flows associated with the bucket are a heavy hitter.

15. The method of claim 10, comprising:
based on a key value associated with a packet not being stored in the data and based on a count of votes that a flow of a packet is not a heavy hitter flow, forwarding the packet.

16. The method of claim 10, comprising:
based on a key value associated with a packet being stored in the data:
cause performance of an action, wherein the action comprises one or more of: queue the packet into a lower-priority queue; perform flow rate control; cause the packet to be routed through a high-bandwidth path; identify congestion and report congestion to a sender of the packet; or drop the packet.

17. At least one non-transitory computer-readable medium comprising instructions stored thereon, that if executed by a packet processing circuitry, cause the packet processing circuitry to:
access a data corresponding to multiple bins, respective bins associated with multiple packet flows and
for respective bins:
identify a single flow associated with a bin of the multiple bins as a candidate heavy hitter flow and
determine a different packet flow as the candidate heavy hitter flow for the bin of the multiple bins.

18. The at least one non-transitory computer-readable medium of claim 17, wherein the identify a single flow associated with a bin of the multiple bins as a candidate heavy hitter flow is based on monitored traffic volume of multiple packet flows associated with a respective bin.

19. The at least one non-transitory computer-readable medium of claim 17, wherein the packet processing circuitry is to monitor traffic of non-heavy hitter candidate flows in a single datum.

20. The at least one non-transitory computer-readable medium of claim 17, comprising instructions stored thereon, that if executed by the packet processing circuitry, cause the packet processing circuitry to:
based on a flow of a received packet corresponding to the different packet flow and the candidate heavy hitter flow, increase a heavy hitter flow vote count for the candidate heavy hitter flow.
